(19) United States
(12) Patent Application Publication
(10) Pub. No.: US 2010/0128113 A1
(43) Pub. Date: May 27, 2010

(54) Computer Device Capable of Providing Stereoscopic Image

(75) Inventors: Chih-Ho Hsieh, Taipei (TW); Chi-Feng Lee, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTeK Computer Inc., Taipei (TW)

(21) Appl. No.: 12/608,106

(22) Filed: Oct. 29, 2009

(30) Foreign Application Priority Data
Nov. 27, 2008 (TW) 97145977

(51) Int. Cl. H04N 13/04

(52) U.S. Cl. 348/51; 348/E13.001

(57) ABSTRACT

A computer device capable of providing a stereoscopic image is provided. The compute device includes a host, a display, and a stereoscopic display film. The host reads an image data having 3D information. The display is connected with the host. The display displays an image converted from the image data. The display has a fixing element. The stereoscopic display film is detachably fixed at front side of the display via the fixing element, and the image is converted to a stereoscopic image with a stereoscopic effect.

This application claims the benefit of Taiwan application Serial No. 97145977, filed Nov. 27, 2008, the subject matter of which is incorporated herein by reference.

### BACKGROUND OF THE INVENTION

1. Field of the Invention

The invention relates to a computer device and, more particularly, to a computer device for providing a stereoscopic image.

2. Description of the Related Art

In recent years, a display technology gradually becomes mature. At the same time, a rapid developing display technology is a stereoscopic image display technology. The stereoscopic image display technology is a display technology which can provide stereoscopic images with a three dimensional (3D) effect.

The stereoscopic image display technology utilizes a binocular disparity property of human eyes to allow a user to have a 3D feel when he or she watches a processed stereoscopic image. For example, the user can wear a pair of special two-color glasses to watch the stereoscopic image composing of a green image and a red image to feel the stereoscopic image with the stereoscopic effect. Furthermore, a user can utilize a projector to project two images on a screen and stack two polarizers in front of the projector. Consequently, once the user wear a pair of polarizing stereoscopic glasses whose left and right glasses have different angles, the user can see a stereoscopic image with the stereoscopic effect.

However, if the stereoscopic image with the stereoscopic effect is provided in the above ways, the user needs to wear a pair of special stereoscopic glasses. Additionally, the cost of the polarizing stereoscopic glasses and the projector is expensive, the user needs to go to a special place (such as a cinema) to watch the stereoscopic image with the stereoscopic effect. As a result, it is not convenience for the user.

### BRIEF SUMMARY OF THE INVENTION

The invention relates to a computer device capable of providing a stereoscopic image and improving the facility for a user to get the stereoscopic image with the stereoscopic effect. The invention helps to popularize the computer device capable of providing the stereoscopic image.

According one aspect of the invention, the invention provides a computer device capable of providing a stereoscopic image. The computer device includes a host, a display, and a stereoscopic display film. The host is used for reading image data having 3D information. The display is connected with the host the display to display the image data converted from an image. The display has a fixing element. The stereoscopic display film is detachably fixed at a front side of the display via the fixing element. The image is converted to a stereoscopic image with a stereoscopic effect via the stereoscopic display film.

These and other features, aspects and advantages of the present invention will become better understood with regard to the following description, appended claims, and accompanying drawings.

### BRIEF DESCRIPTION OF THE DRAWINGS

FIG. 1 is a block diagram showing a computer device according to a first embodiment of the invention;

FIG. 2 is a schematic diagram showing the computer device in FIG. 1 from a view angle according to an embodiment of the invention;

FIGS. 3A˜3C are exploded diagrams showing the computer device in FIG. 2 whose stereoscopic display film is fixed at a front side of the display via fasteners according to an embodiment of the invention;

FIG. 4A is a schematic diagram showing the computer device in FIG. 1 from another view angle according to another embodiment of the invention;

FIG. 4B is a section diagram showing the section taken along a line L-L′ of the computer device in FIG. 4A; and

FIGS. 5A˜5C is an exploded diagram showing a process of containing a stereoscopic display film into a back cover of a display according to an embodiment of the invention.

### DETAILED DESCRIPTION OF THE EMBODIMENTS

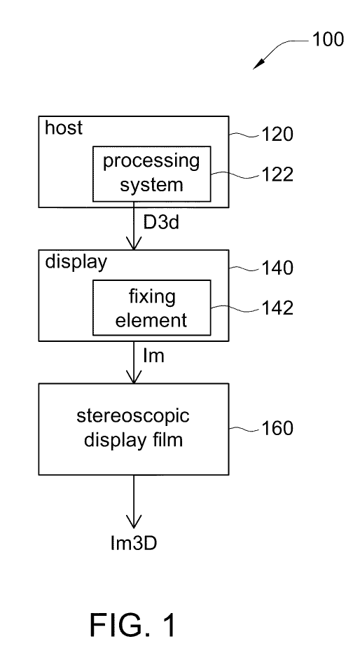

FIG. 1 is a block diagram showing a computer device 100 for providing a stereoscopic image according to a first embodiment of the invention. The computer device 100 can be used for providing a stereoscopic image Im3D. The computer device 100 includes a host 120, a display 140, and a stereoscopic display film 160.

The host 120 is used for reading the image data D3d having 3D information. The display 140 is connected with the host 120. The display 140 is used for displaying an image Im converted from the image data D3d. The display 140 has a fixing element 142.

The stereoscopic display film 160 is detachably fixed at a front side of the display 140 via the fixing element 142. The front side of the display 140 is a side used for displaying the image Im. The stereoscopic display film 160 disposed at the front side of the display 140 can be attached on the display 140. Consequently, the image Im can be converted to the stereoscopic image Im3D with the stereoscopic effect via the stereoscopic display film 160.

Additionally, a processing system 122 is provided in the host 120. The processing system 122 is used for converting two-dimensional (2D) image data to the image data D3d having the 3D information. In this usage, the image data D3d converted by the processing system 122 is corresponding to the stereoscopic display film 160. As a result, the image Im can be converted to the stereoscopic image Im3D having the stereoscopic effect via the stereoscopic display film 160.

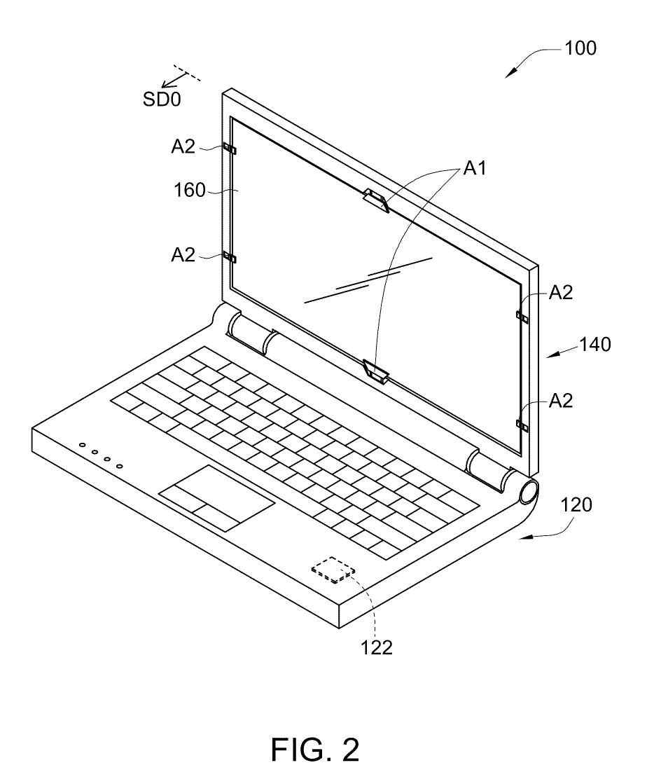

The disposition of components of the computer device 100 and how the image data D3d is corresponding to the stereoscopic display film 160 are explained in the following example. FIG. 2 is a schematic diagram showing the computer device 100 in FIG. 1 from a view angle according to an embodiment of the invention. In this embodiment, the host 120 can directly read a multiple-view stereoscopic image data from an external device or utilize the processing system 122 to convert the 2D image data to the multiple-view stereoscopic image data as the image data D3d having the 3D information. Afterwards, the host 120 transmits the image data D3d to the display 140 to allow the display 140 to display the image Im converted from the image data D3d.

In this embodiment, the stereoscopic display film 160 may be a lenticular lens. In practical usage, the thickness of the lenticular lens is about 0.3 microns to 3 microns. The image data D3d having the 3D information is corresponding to the stereoscopic display film 160, which means that the processing system 122 determines a converting mode to covert the 2D image data to the image data D3d having the 3D information according to a property of the stereoscopic display film 160 (a structure of the lenticular lens such as a grid line number, a grid line distance, or a grid line direction). As a result, the processing system 122 can provide the image data D3d having the 3D information and corresponding to the stereoscopic display film 160 to allow the display 140 to display the image Im at a front side SD0. Afterwards, the image Im becomes the stereoscopic image Im3D via the stereoscopic display film 160. Consequently, the user can see the stereoscopic image Im3D with the stereoscopic effect.

How the stereoscopic display film 160 is detachably fixed to the display 140 via the fixing element 142 is explained in the following example. In FIG. 2, when the multiple fixing element 142 are provided, that is, the display 140 includes multiple fasteners, such as fasteners A1 and A2. The fasteners A1 and A2 are movably disposed around a front side SD0 of the display 140.

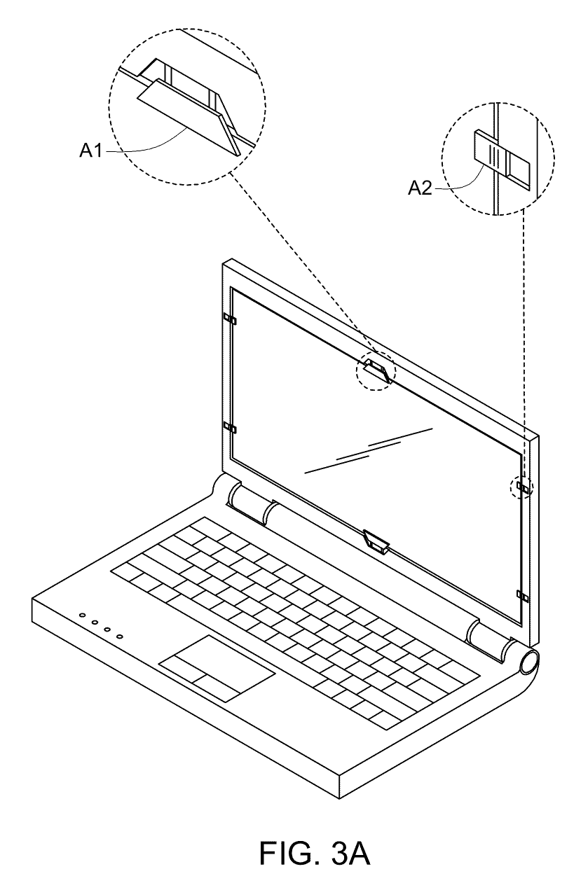

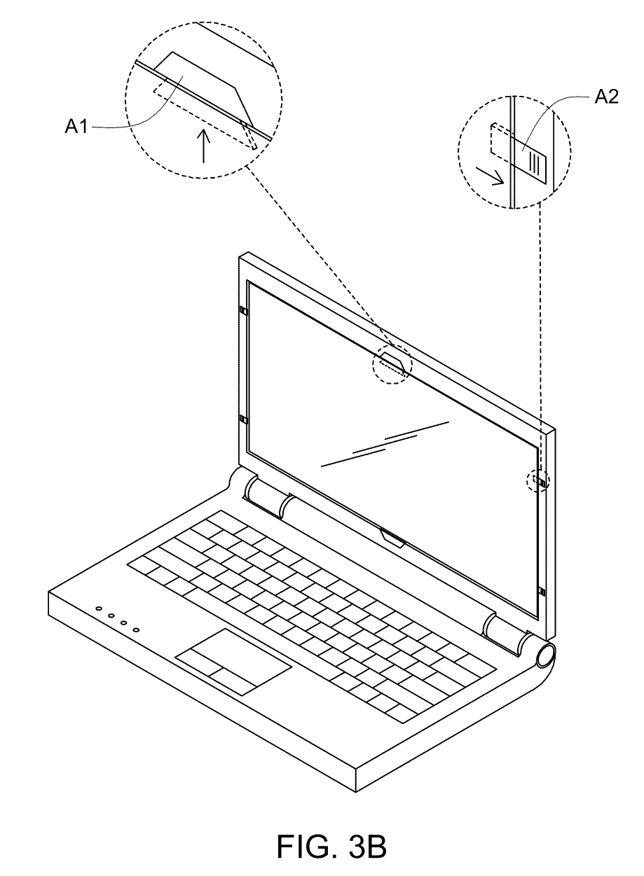

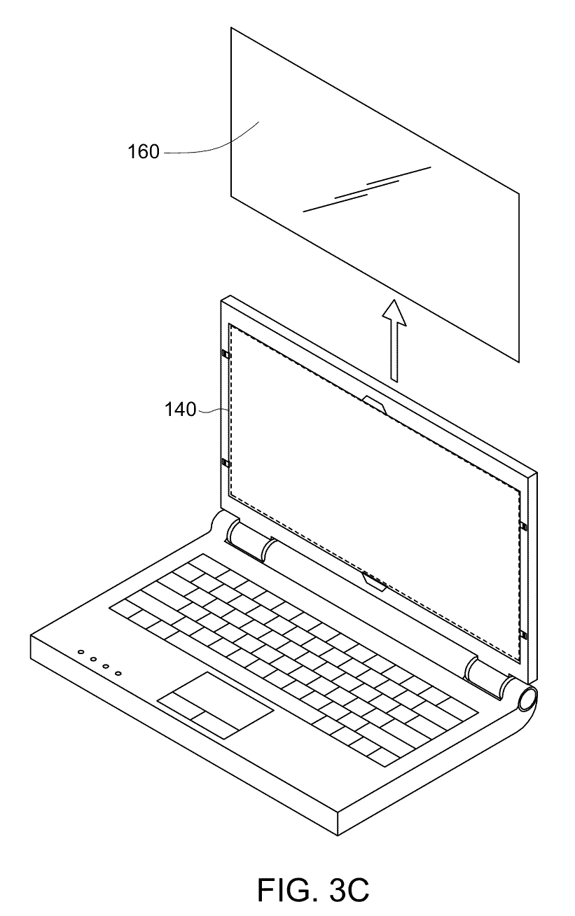

FIGS. 3A˜3C are exploded diagrams showing the computer device 100 in FIG. 2 whose stereoscopic display film 160 is fixed at the front side SD0 of the display 140 via the fasteners A1 and A2 according to an embodiment of the invention. In this embodiment, since the computer device 100 has the fasteners A1 and A2, when the stereoscopic display film 160 is at the front side SD0 of the display 140, the fasteners A1 and A2 are moved to the positions as shown in FIG. 3A to fix the stereoscopic display film 160 on the display 140. Reversely, when the stereoscopic display film 160 needs to be detached, the fasteners A1 and A2 are moved to the positions as shown in FIG. 3B. Afterwards, as shown in FIG. 3C, the stereoscopic display film 160 can be detached from the display 140. As a result, the stereoscopic display film 160 can be detachably fixed at the front side SD0 of the display 140 via the fasteners A1 and A2.

In the above embodiments, the stereoscopic display film 160 is detachably fixed at the front side SD0 of the display 140 via the fasteners A1 and A2. It is just for explaining the embodiment of the invention, but not for limiting the scope of the invention. Other fixing ways also may be used. For example, the stereoscopic display film 160 can be adhered on the display 140, or the stereoscopic display film 160 can be suspended on the display 140. As long as the stereoscopic display film 160 can be detachably fixed at the front side SD0 of the display 140 via the fixing element 142 to produce the stereoscopic image Im3D with the stereoscopic effect, the fixing way is in the scope of the invention.

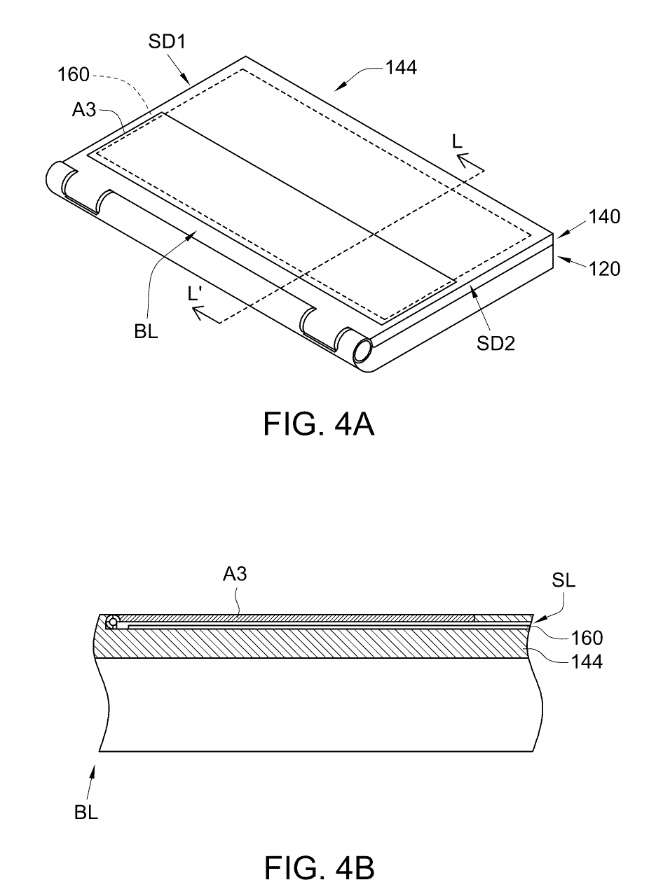

Additionally, after the stereoscopic display film 160 is detached form the display 140, the stereoscopic display film 160 can be collected into the computer device 100. FIG. 4A is a schematic diagram showing the computer device 100 in FIG. 1 from another view angle according to another embodiment of the invention. In this embodiment, the stereoscopic display film 160 is collected into the display 140 via the configuration of the host 120 as shown in FIG. 4A. FIG. 4B is a section diagram showing the section taken along a line L-L′ of the computer device 100 in FIG. 4A.

In this embodiment, a back cover 144 is disposed at back of the display 140. The back of the display 140 may be a side unused for displaying the image Im, which is the side opposite to the front side SD0. The back cover 144 is used for containing the stereoscopic display film 160 detached from the display 140. Two runners are disposed at two sides of the back cover 144, respectively. The two sides of the back cover 144 may be two sides SD1 and SD2 of the back cover 144 as shown in FIG. 4A. The runner may be a runner SL as shown in FIG. 4B. Consequently, the stereoscopic display film 160 can be contained in the back cover 144 via the runners SL at two sides SD1 and SD2 of the back cover 144.

A cover plate A3 may be disposed at the back of the display 140. The cover plate A3 is disposed at the back cover 144 and close to a side of the back cover such as a base side BL 144 in FIG. 4A and FIG. 4B. The cover plate A3 is used for fixing the stereoscopic display film 160 contained in the back cover 144 via the base side BL of the runner SL. As a result, after the stereoscopic display film 160 is detached from the front of the display 140, it can be contained in the back cover 144 at the back of the display 140. Thus, the stereoscopic display film 160 is collected in the computer device 100.

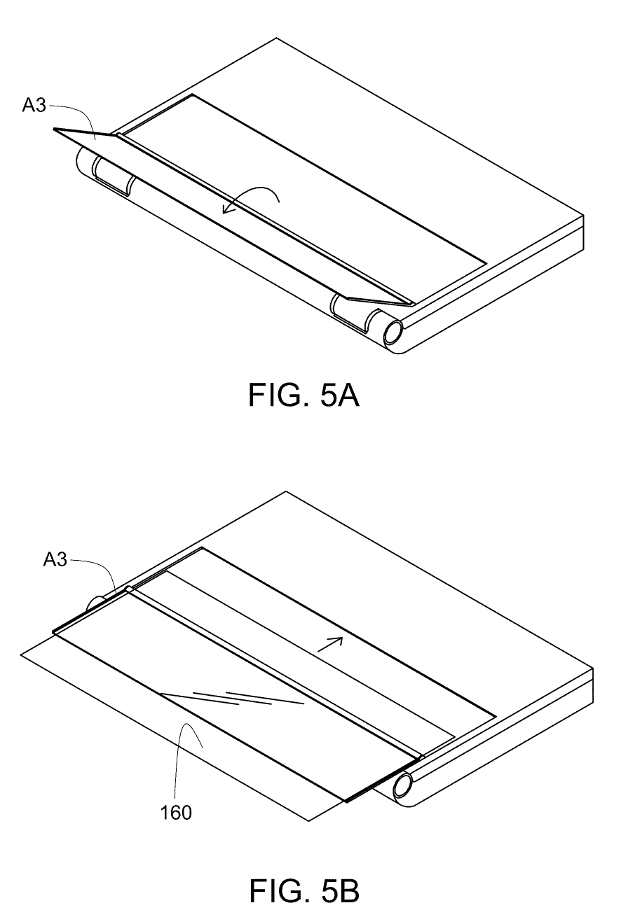

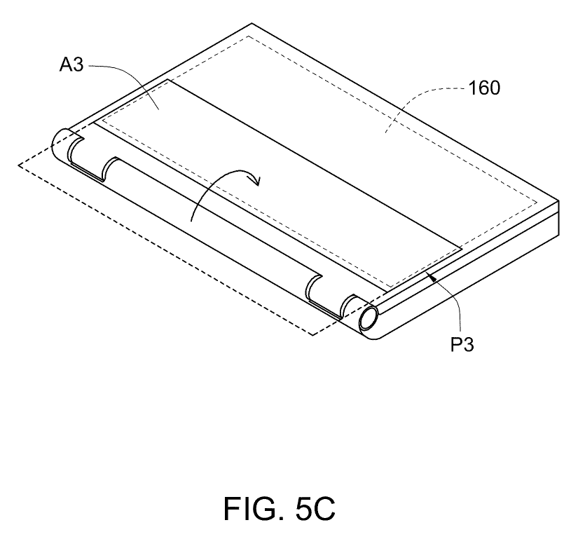

FIGS. 5A˜5C are exploded diagrams showing a process of containing the stereoscopic display film 160 into the back cover 144 of the display 140 according to an embodiment of the invention. The cover plate A3 is moved to a position in which the stereoscopic display film 160 can be fastened to the runner SL. In the position of the cover plate A3 as shown in FIG. 5A, the stereoscopic display film 160 can be put in the back cover 144 via the runner SL.

Afterwards, as shown in FIG. 5B, the stereoscopic display film 160 is put in the back cover 144 via the runners SL. After the stereoscopic display film 160 is all contained in the back cover 144, the cover plate A3 is moved to a position, such as the position of the cover plate A3 as shown in FIG. 5C, in which the stereoscopic display film 160 can be fixed. As a result, via the runner SL of the back cover 144 and the cover plate A3, the stereoscopic display film 160 can be contained in the back cover 144 of the display 140 and fixed.

Additionally, the stereoscopic display film 160 is contained in the display 140 via the back cover at back of the display 140. It is just an example for explaining, but not for limiting the invention. In other usages, the stereoscopic display film 160 may be contained in other parts of the computer device 100. For example, a back cover may be disposed at the back of the host 120 to contain the stereoscopic display film 160 detached from the display 140. As long as the stereoscopic display film 160 can be detached from the front of the display 140 and contained in the computer device 100, the way is in the scope of the invention.

The computer device 100 in the embodiments of the invention may be a notebook. When a user uses the computer device 100, the stereoscopic image Im3D with the stereoscopic effect can be obtained by utilizing the host 120 to read the image data D3d having the 3D information or executing software which can make the stereoscopic image data D3d in the processing system 122, and disposing the stereoscopic display film 160 at the front side SD0 of the display 140. As a result, via the computer device 100 which can provide the stereoscopic image, users may obtain the stereoscopic image with the stereoscopic effect conveniently and do not need to wear a pair of the special stereoscopic glasses, or go to a special place (such as a cinema) providing the stereoscopic images. Consequently, users may obtain the stereoscopic images more conveniently. Additionally, since they may obtain them more conveniently, the invention helps to popularize the computer device which can provide the stereoscopic image.

Via the stereoscopic display film detachably fixed to front of the display, when the host reads the image data having the 3D information, the computer device which can provide the stereoscopic image makes the display produce the stereoscopic image with the stereoscopic effect. As a result, users may obtain the stereoscopic images more conveniently. The invention helps to popularize the computer device which can provide the stereoscopic image.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer device capable of providing a stereoscopic image, comprising:
a host for reading image data having 3D information;
a display connected with the host, wherein the display is used for displaying an image converted from the image data, and the display has a fixing element; and
a stereoscopic display film detachably fixed at a front side of the display via the fixing element, wherein the image is converted to the stereoscopic image with a stereoscopic effect via the stereoscopic display film.

2. The computer device capable of providing the stereoscopic image according to claim 1, wherein the stereoscopic display film is a lenticular lens.

3. The computer device capable of providing the stereoscopic image according to claim 2, wherein the thickness of the lenticular lens is 0.3 microns to 3 microns.

4. The computer device capable of providing the stereoscopic image according to claim 1, wherein when the multiple fixing elements are provided, the fixing elements are movably disposed around the front side of the display.

5. The computer device capable of providing the stereoscopic image according to claim 1, wherein a back cover is disposed at the back of the host to contain the stereoscopic display film detached from the display.

6. The computer device capable of providing the stereoscopic image according to claim 1, wherein a back cover is disposed at the back of the display to contain the stereoscopic display film detached from the display.

7. The computer device capable of providing the stereoscopic image according to claim 6, wherein each of two sides of the back cover has a runner.

8. The computer device capable of providing the stereoscopic image according to claim 6, wherein a cover plate is disposed at the back of the display, the cover plate is disposed at the back cover and close to a side of the back cover, and the cover plate is used to fix the stereoscopic display film in the back cover.

9. The computer device capable of providing the stereoscopic image according to claim 1, wherein a processing system is provided in the host.

10. The computer device capable of providing the stereoscopic image according to claim 9, wherein the stereoscopic display film is a lenticular lens, the processing system coverts 2D image data to the image data having the 3D information according to at least one of a grid line number, a grid line distance, and a grid line direction of the lenticular lens.
